(19) United States
(12) Patent Application Publication
(10) Pub. No.: US 2011/0126466 A1
(43) Pub. Date: Jun. 2, 2011

(54) DOOR OPENING AND CLOSING APPARATUS FOR VEHICLE

(75) Inventors: Koji ADACHI, Kariya-shi (JP); Masayuki Uchitsunemi, Chiryu-shi (JP)

(73) Assignee: AISIN SEIKI KABUSHIKI KAISHA, Kariya-shi (JP)

(21) Appl. No.: 12/947,270

(22) Filed: Nov. 16, 2010

(30) Foreign Application Priority Data
Nov. 27, 2009 (JP) 2009-269869

(51) Int. Cl. B60J 5/06; E05F 11/54

(52) U.S. Cl. 49/262

(57) ABSTRACT

A door opening and closing apparatus for a vehicle includes a support member adapted to be fixed at a door for the vehicle and including first and second door support wall portions, an arm member including first and second arm support wall portions positioned to overlap relative to the first and second door support wall portions respectively in the vertical direction, the arm member being rotatably connected to the support member by a hinge pin, a roller support wall portion formed at the first arm support wall portion and extending upwardly, a roller rotatably connected to the roller support wall portion, a cable, a drive member opening and closing the door by reeling in or out the cable, and a pulley mechanism provided at a lower side of the first arm support wall portion and guiding an arrangement of the cable.

### CROSS REFERENCE TO RELATED APPLICATIONS

This application is based on and claims priority under 35 U.S.C. §119 to Japanese Patent Application 2009-269869, filed on Nov. 27, 2009, the entire content of which is incorporated herein by reference.

### TECHNICAL FIELD

This disclosure relates to a door opening and closing apparatus for a vehicle.

### BACKGROUND DISCUSSION

A known door opening and closing apparatus for a vehicle is disclosed in JP2003-129746A (which will be hereinafter referred to as Reference 1), for example. FIG. 5 is a perspective view illustrating a door opening and closing apparatus for a vehicle disclosed in Reference 1. As illustrated in FIG. 5, the door opening and closing apparatus includes an arm member 93 rotatably connected about a hinge pin 92 relative to a hinge bracket 91 that is fixed to a vehicle door. The arm member 93 includes a support wall portion 93a which extends upward and at which a roller 95 is rotatably supported about a rotational shaft 94 that extends in a direction perpendicular to a direction where the support wall portion 93a extends, i.e., in a horizontal direction. The roller 95 is mounted in a rolling manner at a guide rail provided at a vehicle body. According to the door opening and closing apparatus disclosed in Reference 1, a cable of which an end is fixed to the vehicle body is reeled in and out by a drive motor unit provided at the vehicle door to thereby drive the arm member 93. As a result, the vehicle door is opened or closed. A pulley unit 96 is provided at the arm member 93 so as to guide a routing or an arrangement of the cable that is reeled in and out.

According to the door opening and closing apparatus disclosed in Reference 1, a space for mounting the pulley unit 96 is secured at an upper side of the arm member 93. In this case, the arm member 93 is arranged downward relative to the roller 95 by the space for mounting the pulley unit 96, which results in an increase of a vertical length of the support wall portion 93a that extends upward from the arm member 93. Consequently, a support position of the vehicle door relative to the vehicle body (specifically, the guide rail) is separated upwardly from the arm member 93, which may cause a decrease of a rigidity and a space efficiency of the arm member 93.

A need thus exists for a door opening and closing apparatus for a vehicle which is not susceptible to the drawback mentioned above.

### SUMMARY

According to an aspect of this disclosure, a door opening and closing apparatus for a vehicle includes a support member adapted to be fixed at a door for the vehicle and including first and second door support wall portions arranged to overlap each other in a vertical direction of the vehicle, the first door support wall portion being provided at an upper side of the second door support wall portion, an arm member including first and second arm support wall portions arranged to overlap each other in the vertical direction and positioned to overlap relative to the first and second door support wall portions respectively in the vertical direction, the arm member including a connection wall portion connecting the first and second arm support wall portions to each other, the arm member being rotatably connected to the support member by a hinge pin that penetrates through an overlapping portion between the first and second door support wall portions and the first and second arm support wall portions in the vertical direction, a roller support wall portion formed at the first arm support wall portion and extending upwardly, a roller rotatably connected to the roller support wall portion via a rotational shaft that is provided at the roller support wall portion, the roller being adapted to be mounted in a rolling manner at a guide rail that is provided at a vehicle body, a cable of which an end is adapted to be fixed to the vehicle body, a drive member adapted to be provided at the door for the vehicle and opening and closing the door by reeling in or out the cable, and a pulley mechanism provided at a lower side of the first arm support wall portion and guiding an arrangement of the cable.

According to another aspect of the disclosure, a door opening and closing apparatus for a vehicle includes a door opening and closing apparatus for a vehicle includes a support member adapted to be fixed at a door for the vehicle and including first and second door support wall portions arranged to overlap each other in a vertical direction of the vehicle, the first door support wall portion being provided at an upper side of the second door support wall portion, an arm member including first and second arm support wall portions arranged to overlap each other in the vertical direction and positioned to overlap relative to the first and second door support wall portions respectively in the vertical direction, the arm member including a connection wall portion connecting the first and second arm support wall portions to each other, the arm member being rotatably connected to the support member by a hinge pin that penetrates through an overlapping portion between the first and second door support wall portions and the first and second arm support wall portions in the vertical direction, a roller support wall portion formed at the first arm support wall portion and extending upwardly, a roller rotatably connected to the roller support wall portion via a rotational shaft that is provided at the roller support wall portion, the roller being adapted to be mounted in a rolling manner at a guide rail that is provided at a vehicle body, a cable of which an end is adapted to be fixed to the vehicle body, a drive member adapted to be provided at the door for the vehicle and opening and closing the door by reeling in or out the cable, and a pulley mechanism provided at a lower side of the first arm support wall portion and guiding an arrangement of the cable. The hinge pin includes a first hinge pin provided at the overlapping portion between the first door support wall portion and the first arm support wall portion and a second hinge pin provided at the overlapping portion between the second door support wall portion and the second arm support wall portion. The pulley mechanism is arranged between the first hinge pin and the second hinge pin.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a schematic view illustrating a door opening and closing apparatus for a vehicle according to an embodiment disclosed here;

FIG. 2A is a plan view of a guide roller unit and a surrounding structure thereof provided at the door opening and closing apparatus;

FIG. 2B is an enlarged view of the guide roller unit;

FIG. 3 is cross-sectional view taken along the line illustrated in FIG. 2B;

FIG. 4 is a perspective view of the guide roller unit; and

FIG. 5 is a perspective view illustrating a conventional door opening and closing apparatus for a vehicle.

### DETAILED DESCRIPTION

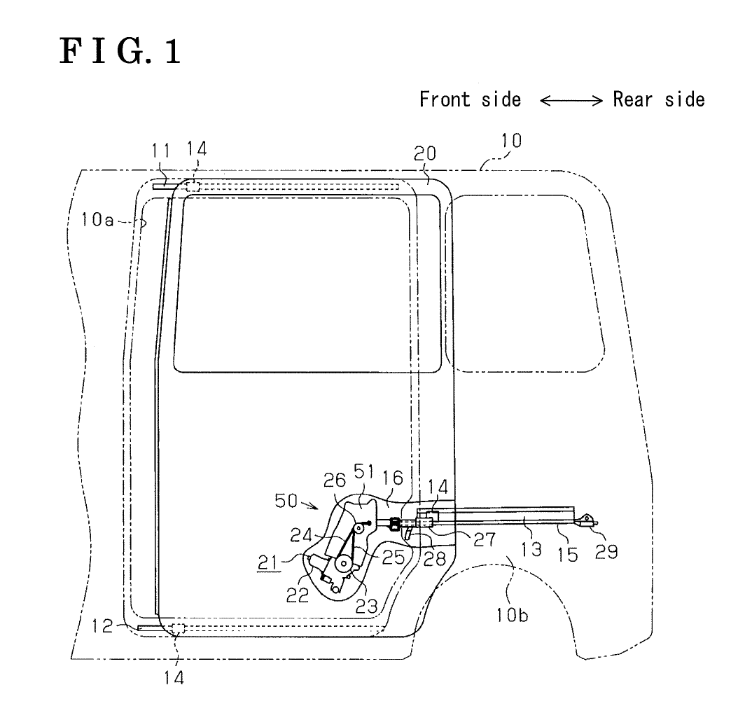

An embodiment disclosed here will be explained with reference to the attached drawings. In the embodiment, directions and orientations such as left, right, front, rear, top, and bottom correspond to those when viewed from an occupant seated in a vehicle, the vehicle being equipped with a door opening and closing apparatus for a vehicle according to the present embodiment. As illustrated in FIG. 1, an upper rail 11 and a lower rail 12 are provided respectively at an upper edge and a lower edge of a door opening 10a formed at a side portion of a body for a vehicle (hereinafter referred to as a vehicle body) 10. In addition, a center rail 13 that extends in a longitudinal direction of the vehicle and that serves as a guide rail is provided at a quarter panel 10b arranged at a rear side of the door opening 10a. The upper rail 11, the lower rail 12, and the center rail 13 support a slide door 20 serving as a door for a vehicle (vehicle door) by means of guide roller units 14 respectively so that the slide door 20 is movable in the longitudinal direction of the vehicle. The slide door 20 opens or closes the door opening 10a by moving in the longitudinal direction of the vehicle. A cable guide 15 is provided at the quarter panel 10b along a lower edge of the center rail 13 over an entire length thereof.

A door unit 50 is attached to a rear end portion of a door inner panel 16 that constitutes the slide door 20. Specifically, the door unit 50 is provided at substantially an intermediate portion of the door inner panel 16 in a height direction (i.e., a vertical direction) of the vehicle. The door unit 50 includes a bracket 51 fixed to the door inner panel 16 by a tightening of a bolt and a nut, for example.

An upper end portion of a drive member 21 is fixed to a lower end portion of the bracket 51 by a tightening of a bolt and a nut, for example. The drive member 21 includes a drive motor 22 and a drum 23 that is arranged at an output shaft of the drive motor 22 and that is rotatably driven by the drive motor 22. A first cable 24 and a second cable 25, each serving as a cable, are wound around the drum 23. Specifically, the first and second cables 24 and 25 are wound around the drum 23 while respective one ends of the first and second cable 24 and 25 engage with the drum 23. The first and second cables 24 and 25 are selectively reeled in and out by the drive member 21.

The first and second cables 24 and 25 extend from the slide door 20 to the vehicle body 10 by passing through a relay pulley 26 connected to an upper end portion of the bracket 51, and a guide pulley mechanism 27 serving as a pulley mechanism and connected to the guide roller unit 14 that slides along the center rail 13. The first and second cables 24 and 25 are routed or arranged in the longitudinal direction of the vehicle along the cable guide 15. The relay pulley 26 is provided to arrange the first and second cables 24 and 25 between a vehicle interior side and a vehicle exterior side relative to the door inner panel 16.

The first cable 24 is guided and arranged towards the front side of the vehicle by the cable guide 15. The first cable 24 is connected to the vehicle body 10 at a front end of the cable guide 15 by means of a tensioner 28 to which the other end of the first cable 24 is connected. The second cable 25 is guided and arranged towards the rear side of the vehicle by the cable guide 15. The second cable 25 is connected to the vehicle body 10 at a rear end of the cable guide 15 by means of a tensioner 29 to which the other end of the second cable 25 is connected.

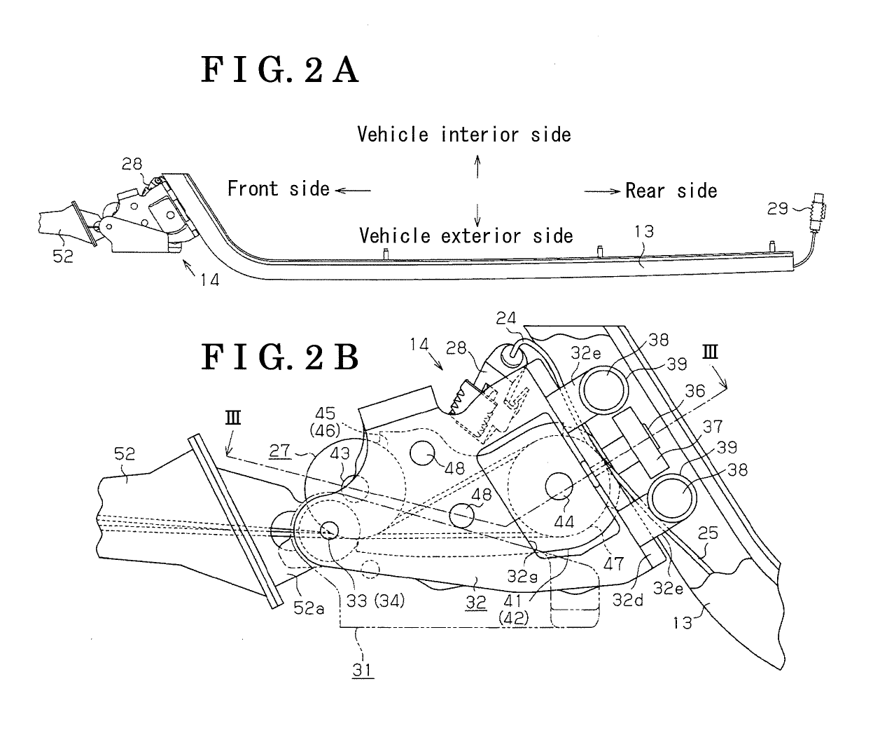

In the aforementioned configuration, in a case where the first cable 24 is reeled out while the second cable 25 is reeled in by the drive member 21, for example, the guide roller units 14 move rearward along the corresponding rails 11 to 13 so that the slide door 20 moves rearward to open the door opening 10a. On the other hand, in a case where the first cable 24 is reeled in while the second cable 25 is reeled out by the drive member 21, the guide roller units 14 move forward along the corresponding rails 11 to 13 so that the slide door 20 moves forward to close the door opening 10a. The rails 11 to 13 are arranged in parallel to one another as illustrated in FIG. 1. A front end of the center rail 13 is bent towards the vehicle interior as illustrated in FIG. 2A so that the slide door 20 is guided in such a manner that an exterior surface of the slide door 20 is substantially coplanar with an exterior surface of the vehicle body 10 (quarter panel 10b) in a fully closed state of the slide door 20. In a state where the slide door 20 is open, the slide door 20 is arranged on the exterior surface of the vehicle body 10 (the quarter panel 10b).

Next, each of the guide roller units 14 and a surrounding structure thereof will be further explained with reference to FIGS. 2A, 2B, 3, and 4.

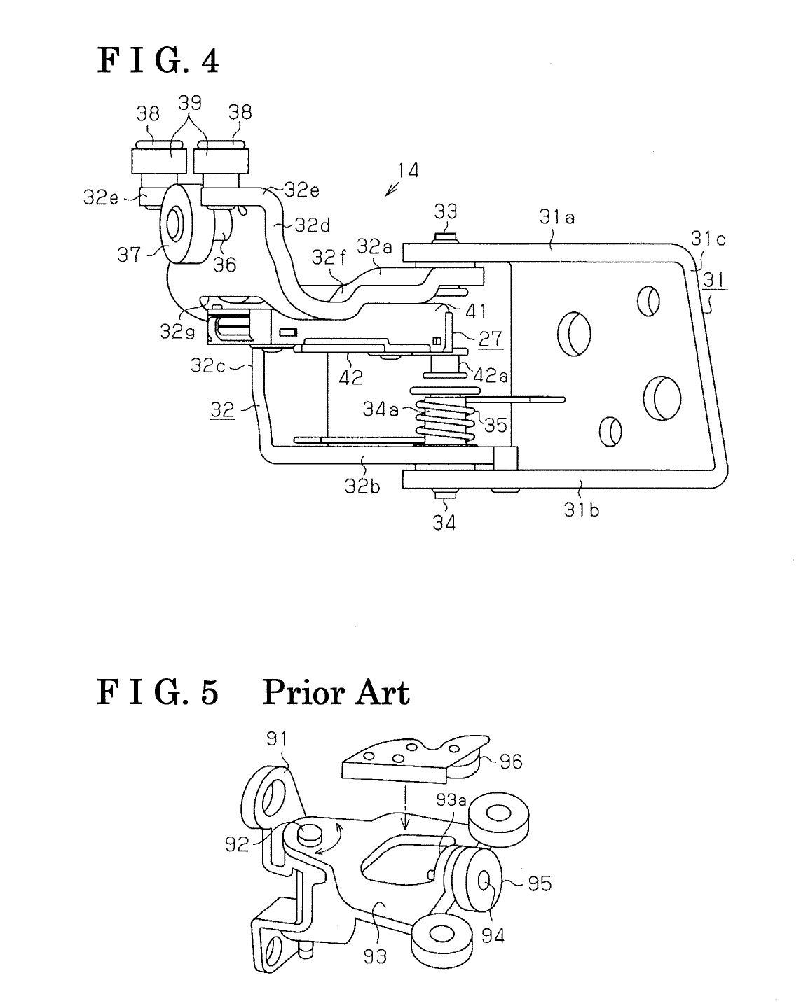

As illustrated in FIG. 4, the guide roller unit 4 includes a hinge bracket 31 serving as a support member made of a metallic plate, for example. The hinge bracket 31 is substantially formed into a U-shape including a pair of door support wall portions 31a and 31b (i.e., an upper door support wall portion 31a and a lower door support wall portion 31b) that serves as first and second door support wall portions. The pair of door support wall portions 31a and 31b is arranged to overlap each other in the vertical direction of the vehicle. The hinge bracket 31 also includes a door connecting wall portion 31c that connects the pair of door support wall portions 31a and 31b to each other. The hinge bracket 31 is fixed to the slide door 20 via the door connecting wall portion 31c by means of tightening of a bolt and a nut, for example.

The guide roller unit 14 also includes an arm member 32 made of a metallic plate, for example. As illustrated in FIG. 4, the arm member 32 is formed into substantially a U-shape including a pair of arm support wall portions 32a and 32b (i.e., an upper arm support wall portion 32a and a lower arm support wall portion 32b) that serves as first and second arm support wall portions. The pair of arm support wall portions 32a and 32b is arranged to overlap each other in the vertical direction. The arm member 32 also includes an arm connecting wall portion 32c that connects the pair of arm support wall portions 32a and 32b to each other. The arm member 32 is rotatably connected to the hinge bracket 31 via hinge pins 33 and 34 serving as first and second hinge pins. The hinge pin 33 penetrates in the vertical direction through the upper door support wall portion 31a and the upper arm support wall portion 32a that is arranged at a lower side of the upper door support wall portion 31a. The hinge pin 34 penetrates in the vertical direction through the lower door support wall portion 31b and the lower arm support wall portion 32b that is arranged at an upper side of the lower door support wall portion 31b so as to be coaxial with the hinge pin 33.

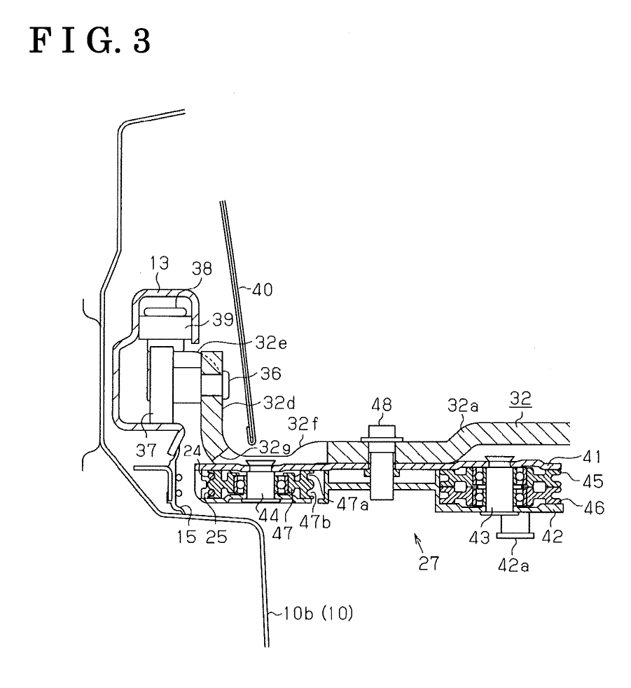

As illustrated in FIGS. 3 and 4, the arm member 32 includes a roller support wall portion 32d that extends upwardly from an end portion of the upper arm support wall portion 32a facing the center rail 13. A rotational shaft 36 penetrates through the roller support wall portion 32d in the horizontal direction (i.e., in a thickness direction thereof) (i.e., the rotational shaft 36 is provided at the roller support wall portion 32d) while entering an inner portion of the center rail 13. In addition, a roller 37 is rotatably supported at the rotational shaft 36 and is rotatably connected to the roller support wall portion 32d. The roller 37 is attached to or mounted at a bottom wall of the center rail 13 in a rolling manner so as to support a load of the slide door 20 that is supported by the center rail 13 (the vehicle body 10). A vertical length of the roller support wall portion 32d that extends upward from the upper arm support wall portion 32a is specified to be an appropriate value so as to ensure a support strength of the roller 37 (the rotational shaft 36) relative to the slide door 20. The arm member 32 also includes a pair of support pieces 32e that extends in parallel to the rotational shaft 36 in the horizontal direction from an upper end of the roller support wall portion 32d so as to enter the inner portion of the center rail 13 and to sandwich the rotational shaft 36 from both sides in the horizontal direction. Then, rotational shafts 38 penetrate through the pair of support pieces 32e in the vertical direction (i.e., in a thickness direction thereof) and support respective vertical rollers 39 so that the vertical rollers 39 are rotatable. The vertical rollers 39 are guided at an upper wall (an upper portion) of the center rail 13 so as to move the slide door 20 by sliding along the center rail 13. As described above, the front end of the center rail 13 is bent towards the vehicle interior. The guide roller unit 14 guided by the center rail 13 allows the longitudinal movement of the slide door 20 by moving the arm member 32 relative to the hinge bracket 31 about the hinge pins 33 and 34.

As illustrated in FIG. 4, the hinge pin 34 includes a guide portion 34a having substantially a column shape and extending upward relative to the arm support wall portion 32b. One end of a torsion spring 35 serving as a biasing member that prevents the guide portion 34a from being dislocated from the lower arm support wall portion 32b is in pressure contact with the door connecting wall portion 31c while the other end of the torsion spring 35 is in pressure contact with the arm connecting wall portion 32c. The torsion spring 35 absorbs vibrations around the hinge pins 33 and 34 mounted at the hinge bracket 31 and the arm member 32 specifically when the slide door 20 is in the fully closed state.

The arm member 32 further includes a relief portion 32f having a downward U-shape in a cross section in the vicinity of the roller support wall portion 32d of the arm member 32. That is, the relief portion 32f is dented downward. As illustrated in FIG. 3, a cover member 40 is provided at the vehicle body 10 (the quarter panel 10b) so as to cover an opening portion of the center rail 13, at which the roller 37 and the like are mounted, over an entire length in the longitudinal direction in addition to the roller support wall portion 32d. The relief portion 32f faces the cover member 40 so that a vertical length of the cover member 40 is elongated downward to thereby further securely prevent an exposure of the roller support wall portion 32d, and the like.

Further, the arm member 32 includes a bore 32g penetrating in the vertical direction through a center of the relief portion 32f and having substantially a rectangular shape. The guide pulley mechanism 27 is attached at a lower side of the upper arm support wall portion 32a. At this time, the bore 32g serves as a portion of a void where the guide pulley mechanism 27 is arranged. In addition, the hinge bracket 31 and the arm member 32 are connected to each other by the hinge pins 33 and 34 that are separately arranged in the vertical direction as illustrated in FIG. 4, thereby forming a void between the hinge pins 33 and 34 where axial lines (axes) of the hinge pins 33 and 34 are released. The guide pulley mechanism 27 is arranged at a lower side of the upper arm support wall portion 32a while effectively utilizing the void formed between the hinge pins 33 and 34. Although the guide pulley mechanism 27 and the cables 24 and 25 guided by the guide pulley mechanism 27 cross the axial lines of the hinge pins 33 and 34, each of the guide pulley mechanism 27 and the cables 24 and 25 is positioned at a different height from the hinge pin 33 or 34 and is thus prevented from interfering with the hinge pins 33 and 34.

That is, the guide pulley mechanism 27 includes housings 41 and 42, forming an accommodating void, and a pair of guide pulleys 45 and 46 (i.e., an upper guide pulley 45 and a lower guide pulley 46). The pair of guide pulleys 45 and 46 is rotatably supported about a support pin 43 of which an axis extends in the vertical direction in the vicinity of the hinge pin 33. In addition, the guide pulley mechanism 27 includes a guide pulley 47 rotatably supported about a support pin 44 of which an axis extends in the vertical direction in the vicinity of the roller support wall portion 32d. The guide pulley 47 includes a pair of pulley portions 47a and 47b (i.e., an upper pulley portion 47a and a lower pulley portion 47b) integrally formed with each other while overlapping in the vertical direction and each having an outer peripheral groove. The guide pulley mechanism 27 is tightened to the arm support wall portion 32a by means of multiple fasteners 48 such as bolts penetrating through the housings 41 and 42 in the vertical direction between the guide pulleys 45, 46 and the guide pulley 47 as illustrated in FIGS. 2B and 3.

The first cable 24 reeled in and out by the drive member 21 engages with the upper guide pulley 45 in a counterclockwise rotation direction and with the upper pulley portion 47a of the guide pulley 47 in the counterclockwise rotation direction in FIG. 2B so as to be guided towards the vehicle front side along the center rail 13 (cable guide 15). The second cable 25 engages with the lower guide pulley 46 in the counterclockwise rotation direction and with the lower pulley portion 47b of the guide pulley 47 in a clockwise rotation direction in FIG. 2B so as to be guided towards the vehicle rear side along the center rail 13 (cable guide 15). Accordingly, the first and second cables 24 and 25 are arranged in such a manner to form substantially collectively in a shape of a number 6 at the guide pulley mechanism 27.

As illustrated in FIG. 4, the housing 42 includes a shaft portion 42a having substantially a column shape and protruding downwardly towards the hinge pin 34 while being coaxial therewith. In addition, as illustrated in FIG. 2B, a cable insertion member 52 having a cylindrical shape and serving as a pulley mechanism supporting member is attached to the bracket 51. The first and second cables 24 and 25 arranged to extend from the slide door 20 (the relay pulley 26) to the vehicle body 10 (the guide pulley mechanism 27) are inserted into the cable insertion member 52. The cable insertion member 52 is fixed to the bracket 51 (the slide door 20) so as to serve as a guide member guiding the first and second cables 24 and 25 between the slide door 20 and the vehicle body 10. The cable insertion member 52 includes a support piece 52a having substantially a triangle shape and supporting the shaft portion 42a to be rotatable. The support piece 52a is provided so that, for example, in a case where the guide pulley mechanism 27 is mounted at the arm member 32 (the arm support wall portion 32a), the guide pulley mechanism 27 is tentatively assembled on the cable insertion member 52 via the shaft portion 42a to thereby enhance the assembly operation of the guide pulley mechanism 27 relative to the arm member 32. Even when the tentative assembly of the guide pulley mechanism 27 on the cable insertion member 52 is maintained after the completion of the mounting of the guide pulley mechanism 27 at the arm member 32, the shaft portion 42a coaxial with the hinge pin 34 does not affect the operation of the guide pulley mechanism 27, and the like. Of course, in case the shaft portion 42a is released form the cable insertion member 52 after the completion of the mounting of the guide pulley mechanism 27 at the arm member 32, the shaft portion 42a does not affect the operation of the guide pulley mechanism 27.

According to the aforementioned embodiment, the guide pulley mechanism 27 is provided at a lower side of the upper arm support wall portion 32a (i.e., between the upper and lower arm support wall portions 32a and 32b defined to be an inner portion of the arm member 32). As a result, the vertical length of the roller support wall portion 32d that extends upward relative to the upper arm support wall portion 32a is defined to be a minimum length for a connection to the roller 37 (the rotational shaft 36). Thus, the arm member 32 (the arm support wall portion 32a) is positioned further closer at the lower side to a support portion of the vehicle body 10 (the center rail 13) relative to the slide door 20. Consequently, the rigidity and space efficiency of the arm member 32 may increase.

In addition, according to the aforementioned embodiment, the hinge pins 33 and 34 are individually and respectively provided at overlapping portions between the door support wall portions 31a, 31b and the arm support wall portions 32a, 32b. That is, the hinge pin 33 is arranged at the overlapping portion between the upper door support wall portion 31a and the upper arm support wall portion 32a while the hinge pin 34 is arranged at the overlapping portion between the lower door support wall portion 31b and the lower arm support wall portion 32b. Such arrangement may lead to a space reduction for arrangement of the hinge pins 33 and 34 compared to a case where, for example, a single hinge pin is arranged to extend between both the overlapping portions, which are arranged in an overlapping manner in the vertical direction, between the upper door support wall portion 31a and the upper arm support wall portion 32a and between the lower door support wall portion 31b and the lower arm support wall portion 32b. Thus, according to the aforementioned embodiment, even when the guide pulley mechanism 27 or the cables 24 and 25 guided by the guide pulley mechanism 27 is/are arranged so as to cross the axial lines of the hinge pins 33 and 34, the guide pulley mechanism 27 or the cables 24 and 25 is/are prevented from interfering with the hinge pins 33 and 34. The arrangement of the guide pulley mechanism 27 or the cables 24 and 25 may be therefore flexible. Specifically, the guide pulley mechanism 27 is arranged closer to the hinge bracket 31 in the horizontal direction, which causes a reduction of the horizontal length of the arm support wall portion 32a to thereby further improve a rigidity of the arm member 32.

Further, according to the aforementioned embodiment, the relief portion 32f is formed at the upper arm support wall portion 32a so as to dent downward. As a result, the vertical length of the cover member 40 facing the relief portion 32f is elongated in the downward direction, thereby securely preventing an exposure of the roller support wall portion 32d, and the like.

Furthermore, according to the aforementioned embodiment, the guide pulley mechanism 27 is rotatably supported by the cable insertion member 52 at the shaft portion 42a so as to be coaxial with the hinge pin 34. Thus, the guide pulley mechanism 27 is mounted at the arm member 32 (the upper arm support wall portion 32a) in a state where the guide pulley mechanism 27 is tentatively assembled on the cable insertion member 52 by means of the shaft portion 42a, which leads to the enhancement of the assembly operation of the guide pulley mechanism 27 relative to the arm member 32. In this case, after the guide pulley mechanism 27 is mounted at the arm member 32, the guide pulley mechanism 27 and the arm member 32 integrally rotate about the hinge pins 33 and 34. At this time, the guide pulley mechanism 27 rotates relative to the cable insertion member 52 at the shaft portion 42a while being coaxial with the hinge pins 33 and 34. Therefore, even when the tentative assembly of the guide pulley mechanism 27 on the cable insertion member 52 by the shaft portion 42a is maintained after the guide pulley mechanism 27 is mounted at the arm member 32, the operation of the guide pulley mechanism 27 is not affected by such tentative assembly.

Furthermore, according to the aforementioned embodiment, the torsion spring 35 absorbs vibrations or a backlash generated around the hinge pins 33 and 34 positioned at the hinge bracket 31 and the arm member 32.

Furthermore, according to the aforementioned embodiment, the cable insertion member 52 is utilized to support the guide pulley mechanism 27 so that the guide pulley mechanism 27 is rotatable.

The aforementioned embodiment may be modified as follows. As long as the guide pulley mechanism 27 and the cables 24 and 25 guided by the guide pulley mechanism 27 do not cross the axial lines (axes) of the hinge pins 33 and 34, a single hinge pin may be inserted into both the overlapping portions, which are arranged to overlap each other in the vertical direction, between the upper door support wall portion 31a and the upper arm support wall portion 32a and between the lower door support wall portion 31b and the lower arm support wall portion 32b to thereby rotatably connect the door support wall portions 31a and 31b and the arm support wall portions 32a and 32b.

In the aforementioned embodiment, the arm support wall portions 32a and 32b of the arm member 32 are connected to the door support wall portions 31a and 31b of the hinge bracket 31 so as to be disposed at an inner side thereof. That is, the arm member 32 is disposed at an inner side of the hinge bracket 31. Alternatively, in an opposite manner, the hinge bracket 31 may be disposed at the inner side of the arm member 32.

The number of guide pulleys provided at the guide pulley mechanism 27 may be three or more. In addition, the first and second cables 24 and 25 may substantially collectively form in a shape of a number 8 in a plan view.

A single cable connected via the drum 23 may be used instead of two cables of the first and second cables 24 and 25.

In the opening and closing apparatus for the vehicle according to the aforementioned embodiment, the torsion spring 35 is disposed between the hinge bracket 31 and the arm member 32 so as to absorb vibrations around the hinge pins 33 and 34.

According to the aforementioned embodiment, the hinge pin 33 is provided at the overlapping portion between the upper door support wall portion 31a and the upper arm support wall portion 32a and the hinge pin 34 is provided at the overlapping portion between the lower door support wall portion 31b and the lower arm support wall portion 32b.

In addition, the upper arm support wall portion 32a includes the relief portion 32f dented downwardly and facing the cover member 40 that covers an opening portion of the center rail 13 at which the roller 37 is mounted and the roller support wall portion 32d.

Further, the door opening and closing apparatus includes the cable insertion member 52 provided at the slide door 20, wherein the guide pulley mechanism 27 includes the shaft portion 42a rotatably supported by the cable insertion member 52, the shaft portion 42a being coaxial with the hinge pin 33, 34.

Furthermore, the cable insertion member 52 is fixed to the slide door 20 and serves as the guide member guiding the cable 24, 25 between the slide door 20 and the vehicle body 10.

Furthermore, the hinge pin 33 is provided at the overlapping portion between the upper door support wall portion 31a and the upper arm support wall portion 32a, and the hinge pin 34 is provided at the overlapping portion between the lower door support wall portion 31b and the lower arm support wall portion 32b. The torsion spring 35 is provided at the hinge pin 34, one end of the torsion spring 35 making contact with the hinge bracket 31 while the other end of the torsion spring 35 making contact with the arm member 32.

Furthermore, the shaft portion 42a is arranged between the hinge pins 33 and 34.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A door opening and closing apparatus for a vehicle, comprising:
a support member adapted to be fixed at a door for the vehicle and including first and second door support wall portions arranged to overlap each other in a vertical direction of the vehicle, the first door support wall portion being provided at an upper side of the second door support wall portion;
an arm member including first and second arm support wall portions arranged to overlap each other in the vertical direction and positioned to overlap relative to the first and second door support wall portions respectively in the vertical direction, the arm member including a connection wall portion connecting the first and second arm support wall portions to each other, the arm member being rotatably connected to the support member by a hinge pin that penetrates through an overlapping portion between the first and second door support wall portions and the first and second arm support wall portions in the vertical direction;
a roller support wall portion formed at the first arm support wall portion and extending upwardly;
a roller rotatably connected to the roller support wall portion via a rotational shaft that is provided at the roller support wall portion, the roller being adapted to be mounted in a rolling manner at a guide rail that is provided at a vehicle body;
a cable of which an end is adapted to be fixed to the vehicle body;
a drive member adapted to be provided at the door for the vehicle and opening and closing the door by reeling in or out the cable; and
a pulley mechanism provided at a lower side of the first arm support wall portion and guiding an arrangement of the cable.

2. The door opening and closing apparatus according to claim 1, wherein the hinge pin includes a first hinge pin provided at the overlapping portion between the first door support wall portion and the first arm support wall portion and a second hinge pin provided at the overlapping portion between the second door support wall portion and the second arm support wall portion.

3. The door opening and closing apparatus according to claim 1, wherein the first arm support wall portion includes a relief portion dented downwardly and facing a cover member that covers an opening portion of the guide rail at which the roller is mounted and the roller support wall portion.

4. The door opening and closing apparatus according to claim 2, wherein the first arm support wall portion includes a relief portion dented downwardly and facing a cover member that covers an opening portion of the guide rail at which the roller is mounted and the roller support wall portion.

5. The door opening and closing apparatus according to claim 1, further comprising a pulley mechanism support member provided at the door for the vehicle, wherein the pulley mechanism includes a shaft portion capable of being rotatably supported by the pulley mechanism support member, the shaft portion being coaxial with the hinge pin.

6. The door opening and closing apparatus according to claim 2, further comprising a pulley mechanism support member provided at the door for the vehicle, wherein the pulley mechanism includes a shaft portion capable of being rotatably supported by the pulley mechanism support member, the shaft portion being coaxial with the hinge pin.

7. The door opening and closing apparatus according to claim 3, further comprising a pulley mechanism support member provided at the door for the vehicle, wherein the pulley mechanism includes a shaft portion capable of being rotatably supported by the pulley mechanism support member, the shaft portion being coaxial with the hinge pin.

8. The door opening and closing apparatus according to claim 4, further comprising a pulley mechanism support member provided at the door for the vehicle, wherein the pulley mechanism includes a shaft portion capable of being rotatably supported by the pulley mechanism support member, the shaft portion being coaxial with the hinge pin.

9. The door opening and closing apparatus according to claim 1, wherein the pulley mechanism support portion is fixed to the door for the vehicle and serves as a guide member guiding the cable between the door for the vehicle and the vehicle body.

10. The door opening and closing apparatus according to claim 2, wherein the pulley mechanism support portion is fixed to the door for the vehicle and serves as a guide member guiding the cable between the door for the vehicle and the vehicle body.

11. The door opening and closing apparatus according to claim 3, wherein the pulley mechanism support portion is fixed to the door for the vehicle and serves as a guide member guiding the cable between the door for the vehicle and the vehicle body.

12. The door opening and closing apparatus according to claim 4, wherein the pulley mechanism support portion is fixed to the door for the vehicle and serves as a guide member guiding the cable between the door for the vehicle and the vehicle body.

13. The door opening and closing apparatus according to claim 5, wherein the pulley mechanism support portion is fixed to the door for the vehicle and serves as a guide member guiding the cable between the door for the vehicle and the vehicle body.

14. The door opening and closing apparatus according to claim 6, wherein the pulley mechanism support portion is fixed to the door for the vehicle and serves as a guide member guiding the cable between the door for the vehicle and the vehicle body.

15. The door opening and closing apparatus according to claim 7, wherein the pulley mechanism support portion is fixed to the door for the vehicle and serves as a guide member guiding the cable between the door for the vehicle and the vehicle body.

16. The door opening and closing apparatus according to claim 8, wherein the pulley mechanism support portion is fixed to the door for the vehicle and serves as a guide member guiding the cable between the door for the vehicle and the vehicle body.

17. The door opening and closing apparatus according to claim 5, wherein the hinge pin includes a first hinge pin provided at the overlapping portion between the first door support wall portion and the first arm support wall portion and a second hinge pin provided at the overlapping portion between the second door support wall portion and the second arm support wall portion, and a biasing member is provided at one of the first and second hinge pins, one end of the biasing member making contact with the support member while the other end of the biasing member making contact with the arm member.

18. The door opening and closing apparatus according to claim 17, wherein the shaft portion is arranged between the first hinge pin and the second hinge pin.

19. A door opening and closing apparatus for a vehicle, comprising:
a support member adapted to be fixed at a door for the vehicle and including first and second door support wall portions arranged to overlap each other in a vertical direction of the vehicle, the first door support wall portion being provided at an upper side of the second door support wall portion;
an arm member including first and second arm support wall portions arranged to overlap each other in the vertical direction and positioned to overlap relative to the first and second door support wall portions respectively in the vertical direction, the arm member including a connection wall portion connecting the first and second arm support wall portions to each other, the arm member being rotatably connected to the support member by a hinge pin that penetrates through an overlapping portion between the first and second door support wall portions and the first and second arm support wall portions in the vertical direction;
a roller support wall portion formed at the first arm support wall portion and extending upwardly;
a roller rotatably connected to the roller support wall portion via a rotational shaft that is provided at the roller support wall portion, the roller being adapted to be mounted in a rolling manner at a guide rail that is provided at a vehicle body;
a cable of which an end is adapted to be fixed to the vehicle body;
a drive member adapted to be provided at the door for the vehicle and opening and closing the door by reeling in or out the cable; and
a pulley mechanism provided at a lower side of the first arm support wall portion and guiding an arrangement of the cable,
the hinge pin including a first hinge pin provided at the overlapping portion between the first door support wall portion and the first arm support wall portion and a second hinge pin provided at the overlapping portion between the second door support wall portion and the second arm support wall portion,
the pulley mechanism being arranged between the first hinge pin and the second hinge pin.
